(19) United States
(12) Patent Application Publication
(10) Pub. No.: US 2023/0411648 A1
(43) Pub. Date: Dec. 21, 2023

(54) FUEL CELL POWER GENERATION SYSTEM

(71) Applicant: MITSUBISHI HEAVY INDUSTRIES, LTD., Tokyo (JP)

(72) Inventors: Nagao Hisatome, Yokohama-shi (JP); Mitsuyoshi Iwata, Yokohama-shi (JP); Takahiro Machida, Yokohama-shi (JP)

(73) Assignee: MITSUBISHI HEAVY INDUSTRIES, LTD., Tokyo (JP)

(21) Appl. No.: 18/032,721

(22) PCT Filed: Oct. 26, 2021
(86) PCT No.: PCT/JP2021/039396

§ 371 Date: Apr. 19, 2023

(30) Foreign Application Priority Data
Oct. 30, 2020 (JP) 2020-183269

(51) Int. Cl. H01M 8/04089; H01M 8/04537; H01M 8/04746; H01M 8/04858; H01M 8/2425

(52) U.S. Cl. CPC H01M 8/04097; H01M 8/04619; H01M 2008/1293; H01M 8/04932; H01M 8/2425; H01M 8/04761

(57) ABSTRACT

A fuel cell power generation module includes a first fuel cell module, and a second fuel cell module capable of generating power with a first exhaust fuel gas exhausted from the first fuel cell module. It is configured such that a first recirculation line recirculates from a second exhaust fuel gas line through which a second exhaust fuel gas exhausted from the second fuel cell module flows, and the second exhaust fuel gas is supplied to a fuel-side electrode of the second fuel cell module.

### TECHNICAL FIELD

The present disclosure relates to a fuel cell power generation system.

This application claims the priority of Japanese Patent Application No. 2020-183269 filed on Oct. 30, 2020, the content of which is incorporated herein by reference.

### BACKGROUND

A fuel cell for generating power by chemically reacting a fuel gas and an oxidizing gas has characteristics such as excellent power generation efficiency and environmental responsiveness. Among these, a solid oxide fuel cell (SOFC) uses ceramics such as zirconia ceramics as an electrolyte and generates power by supplying, as a fuel gas, a gas such as a gasification gas obtained by producing hydrogen, city gas, natural gas, petroleum, methanol, and a carbon-containing raw material with a gasification facility, and causing reaction in a high-temperature atmosphere of approximately 700° C. to 1,000° C.

Patent Document 1 is an example of a fuel cell power generation system using this type of fuel cell. In Patent Document 1, the utilization rate of supplied fuel in each fuel cell module is improved by cascade-connecting a plurality of fuel cell modules to a fuel gas flow path, making it possible to improve system efficiency.

### CITATION LIST

### Patent Literature

Patent Document 1: JP3924243B

### SUMMARY

### Technical Problem

In a fuel cell power generation system in which the plurality of fuel cell modules are cascade-connected as in Patent Document 1, an exhaust fuel gas exhausted from a fuel cell module in a preceding stage is used in a fuel cell module in a subsequent stage. Therefore, the exhaust fuel gas supplied to the fuel cell module in the subsequent stage has a lower fuel component concentration than the fuel gas supplied to the fuel cell module in the preceding stage. Consequently, the output of the fuel cell module in the subsequent stage is suppressed compared to the fuel cell module in the preceding stage and the amount of heat generated due to power generation is reduced, which may result in making it difficult to maintain a temperature for properly operating the fuel cell modules. It is likely that such situation particularly occurs during partial load operation or during transient operation where a required system load changes, which may impair system stability.

Further, each fuel cell module uses steam to reform a methane component contained in the fuel gas to be used for the power generation reaction. However, since the exhaust fuel gas is supplied from the fuel cell module in the preceding stage to the fuel cell module in the subsequent stage, depending on the power generation state of the fuel cell module in the preceding stage, sufficient steam necessary for the reformulation may not be obtained. In Patent Document 1 described above, the amount of the fuel gas additionally supplied to the fuel cell module in the subsequent stage is determined based on the steam contained in the exhaust fuel gas from the fuel cell module in the preceding stage, thereby controlling S/C (ratio of steam/fuel component). However, since the amount of water contained in the exhaust fuel gas varies depending on the power generation state (load factor, fuel utilization rate, etc.) of the fuel cell module in the preceding stage, it is difficult to maintain the appropriate S/C particularly in the transition when the required system load changes.

At least one aspect of the present disclosure has been made in view of the above, and an object of the present disclosure is to provide a fuel cell power generation system having a stable operating state and capable of achieving good system efficiency in the fuel cell power generation system that includes a plurality of fuel cell modules connected in series (cascade) with respect to the flow of a fuel gas.

### Solution to Problem

In order to solve the above-described problems, at least one aspect of the present disclosure includes: a first fuel cell module capable of generating power with a fuel gas; a first exhaust fuel gas line through which a first exhaust fuel gas exhausted from the first fuel cell module flows; a second fuel cell module capable of generating power with the first exhaust fuel gas; a second exhaust fuel gas line through which a second exhaust fuel gas exhausted from the second fuel cell module flows; and a first recirculation line recirculating from the second exhaust fuel gas line in order to supply the second exhaust fuel gas to a fuel-side electrode of the second fuel cell module.

### Advantageous Effects

According to at least one aspect of the present disclosure, it is possible to provide a fuel cell power generation system having a stable operating state and capable of achieving good system efficiency in the fuel cell power generation system that includes a plurality of fuel cell modules connected in series (cascade) with respect to the flow of a fuel gas.

### BRIEF DESCRIPTION OF DRAWINGS

FIG. 1 is a schematic view of a SOFC module according to an embodiment.

FIG. 2 is a schematic cross-sectional view of a SOFC cartridge composing the SOFC module according to an embodiment.

FIG. 3 is a schematic cross-sectional view of a cell stack composing the SOFC module according to an embodiment.

FIG. 4 is a schematic configuration diagram of a fuel cell power generation system according to an embodiment.

FIG. 5 is a schematic configuration diagram of a fuel cell power generation system according to another embodiment.

FIG. 6 is a graph showing the relationship between a required system load and a power generation output value with respect to the fuel cell power generation system shown in FIG. 4.

FIG. 7 is a diagram showing the operating state of the fuel cell power generation system of FIG. 4 when the required system load is a rated load (100%).

FIG. 8 is a diagram showing the operating state of the fuel cell power generation system of FIG. 4 when the required system load is a minimum load (for example, 20%).

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

In the following, for descriptive convenience, positional relationships among respective components described using expressions “upper” and “lower” with reference to the drawing indicate the vertically upper side and the vertically lower side, respectively. Further, in the present embodiment, as long as the same effect is obtained in the up-down direction and the horizontal direction, the up-down direction in the drawing is not necessarily limited to the vertical up-down direction but may correspond to, for example, the horizontal direction orthogonal to the vertical direction.

Hereinafter, an embodiment in which a solid oxide fuel cell (SOFC) is adopted as a fuel cell composing a fuel cell power generation system will be described. However, in some embodiments, as the fuel cell composing the fuel cell power generation system, a fuel cell of a type other than the SOFC (for example, molten-carbonate fuel cells (MCFC), etc.) may be adopted.

(Configuration of Fuel Cell Module)

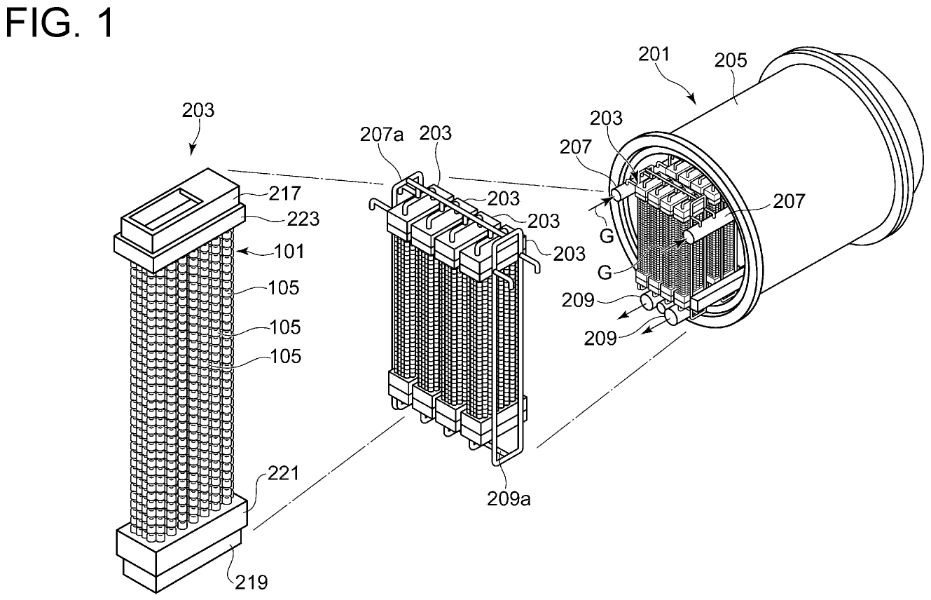

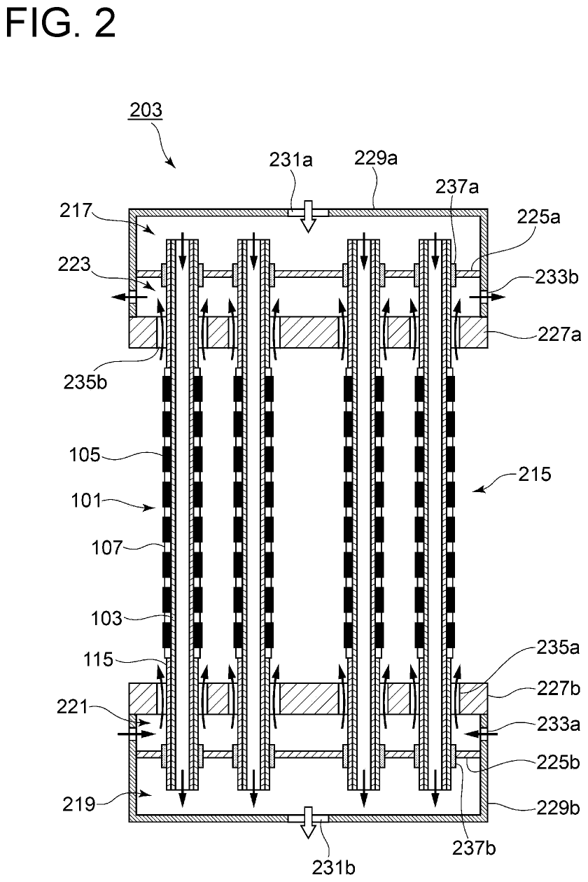

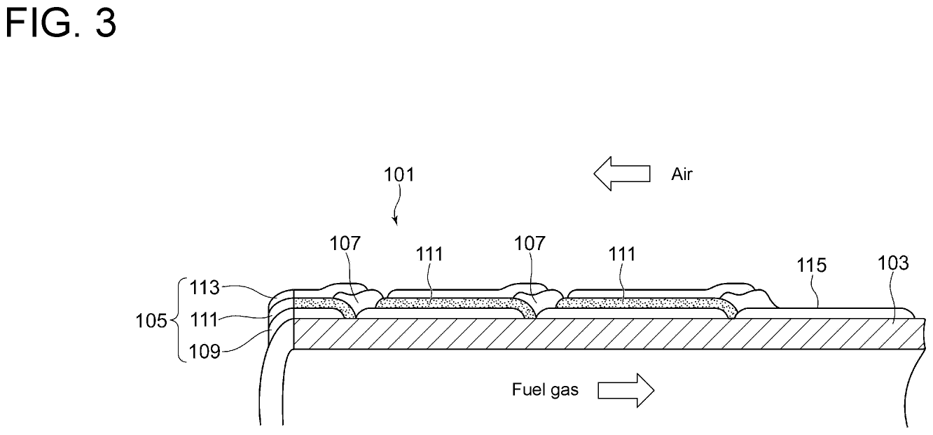

First, a fuel cell module composing a fuel cell power generation system according to some embodiments will be described with reference to FIGS. 1 to 3. FIG. 1 is a schematic view of a SOFC module (fuel cell module) according to an embodiment. FIG. 2 is a schematic cross-sectional view of a SOFC cartridge (fuel cell cartridge) composing the SOFC module (fuel cell module) according to an embodiment. FIG. 3 is a schematic cross-sectional view of a cell stack composing the SOFC module (fuel cell module) according to an embodiment.

As shown in FIG. 1, a SOFC module (fuel cell module) 210 includes, for example, a plurality of SOFC cartridges (fuel cell cartridges) 203 and a pressure vessel 205 for housing the plurality of SOFC cartridges 203. Although FIG. 1 illustrates a cylindrical SOFC cell stack 101, the present disclosure is not necessarily limited thereto and, for example, a flat cell stack may be used. Further, the fuel cell module 210 includes fuel gas supply pipes 207, a plurality of fuel gas supply branch pipes 207a, fuel gas exhaust pipes 209, and a plurality of fuel gas exhaust branch pipes 209a. Furthermore, the fuel cell module 210 includes an oxidant supply pipe (not shown) and an oxidant supply branch pipe (not shown), and an oxidant exhaust pipe (not shown) and a plurality of oxidant exhaust branch pipes (not shown).

The fuel gas supply pipes 207 are disposed outside the pressure vessel 205, are connected to a fuel gas supply part (not shown) for supplying a fuel gas having a predetermined gas composition and a predetermined flow rate according to a power generation amount of the fuel cell module 210, and are connected to the plurality of fuel gas supply branch pipes 207a. The fuel gas supply pipes 207 recirculate and introduce the predetermined flow rate of the fuel gas, which is supplied from the fuel gas supply part described above, to the plurality of fuel gas supply branch pipes 207a. Further, the fuel gas supply branch pipes 207a are connected to the fuel gas supply pipes 207 and are connected to the plurality of SOFC cartridges 203. The fuel gas supply branch pipes 207a introduce the fuel gas supplied from the fuel gas supply pipes 207 to the plurality of SOFC cartridges 203 at the substantially equal flow rate, and substantially uniformize power generation performance of the plurality of SOFC cartridges 203.

The fuel gas exhaust branch pipes 209a are connected to the plurality of SOFC cartridges 203 and are connected to the fuel gas exhaust pipes 209. The fuel gas exhaust branch pipes 209a introduce an exhaust fuel gas exhausted from the SOFC cartridges 203 to the fuel gas exhaust pipes 209. Further, the fuel gas exhaust pipes 209 are connected to the plurality of fuel gas exhaust branch pipes 209a, and a part of each of the fuel gas exhaust pipes 209 is disposed outside the pressure vessel 205. The fuel gas exhaust pipes 209 introduce the exhaust fuel gas derived from the fuel gas exhaust branch pipes 209a at the substantially equal flow rate to the outside of the pressure vessel 205.

The pressure vessel 205 is operated at an internal pressure of 0.1 MPa to approximately 3 MPa and an internal temperature from atmospheric temperature to approximately 550° C., and thus a material is used which has pressure resistance and corrosion resistance to an oxidizing agent such as oxygen contained in an oxidizing gas. For example, a stainless steel material such as SUS304 is suitable.

Herein, in the present embodiment, a mode is described in which the plurality of SOFC cartridges 203 are assembled and housed in the pressure vessel 205. However, the present disclosure is not limited thereto, and for example, a mode can also be adopted in which the SOFC cartridges 203 are housed in the pressure vessel 205 without being assembled.

As shown in FIG. 2, the SOFC cartridge 203 includes the plurality of cell stacks 101, a power generation chamber 215, a fuel gas supply header 217, a fuel gas exhaust header 219, an oxidizing gas (air) supply header 221, and an oxidant exhaust header 223. Further, the SOFC cartridge 203 includes an upper tube plate 225a, a lower tube plate 225b, an upper heat insulating body 227a, and a lower heat insulating body 227b.

In the present embodiment, the fuel gas supply header 217, the fuel gas exhaust header 219, the oxidant supply header 221, and the oxidant exhaust header 223 are disposed as shown in FIG. 2, whereby the SOFC cartridge 203 has a structure such that the fuel gas and the oxidizing gas oppositely flow on the inner side and the outer side of the cell stack 101. However, this is not always necessary and, for example, the fuel gas and the oxidizing gas may flow in parallel on the inner side and the outer side of the cell stack 101 or the oxidizing gas may flow in a direction orthogonal to the longitudinal direction of the cell stack 101.

The power generation chamber 215 is an area formed between the upper heat insulating body 227a and the lower heat insulating body 227b. The power generation chamber 215 is an area in which a single fuel cell 105 of the cell stack 101 is disposed, and is an area in which the fuel gas and the oxidizing gas are electrochemically reacted to generate power. Further, a temperature in the vicinity of the central portion of the power generation chamber 215 in the longitudinal direction of the cell stack 101 is monitored by a temperature measurement part (a temperature sensor such as a thermocouple), and becomes a high-temperature atmosphere of approximately 700° C. to 1,000° C. during a steady operation of the fuel cell module 210.

The fuel gas supply header 217 is an area surrounded by an upper casing 229a and the upper tube plate 225a of the SOFC cartridge 203, and communicates with the fuel gas supply branch pipe 207a through a fuel gas supply hole 231a disposed at the top of the upper casing 229a. Further, the plurality of cell stacks 101 are joined to the upper tube plate 225a by a sealing member 237a, and the fuel gas supply header 217 introduces the fuel gas, which is supplied from the fuel gas supply branch pipe 207a via the fuel gas supply hole 231a, into substrate tubes 103 of the plurality of cell stacks 101 at the substantially uniform flow rate and substantially uniformizes the power generation performance of the plurality of cell stacks 101.

The fuel gas exhaust header 219 is an area surrounded by a lower casing 229b and the lower tube plate 225b of the SOFC cartridge 203, and communicates with the fuel gas exhaust branch pipe 209a (not shown) through a fuel gas exhaust hole 231b provided in the lower casing 229b. Further, the plurality of cell stacks 101 are joined to the lower tube plate 225b by a sealing member 237b, and the fuel gas exhaust header 219 collects the exhaust fuel gas, which is supplied to the fuel gas exhaust header 219 through the inside of the substrate tubes 103 of the plurality of cell stacks 101, and introduces the collected exhaust fuel gas to the fuel gas exhaust branch pipe 209a via the fuel gas exhaust hole 231b.

The oxidizing gas having the predetermined gas composition and the predetermined flow rate is recirculated to the oxidant supply branch pipe according to the power generation amount of the fuel cell module 210, and is supplied to the plurality of SOFC cartridges 203. The oxidant supply header 221 is an area surrounded by the lower casing 229b, the lower tube plate 225b, and the lower heat insulating body (support) 227b of the SOFC cartridge 203, and communicates with the oxidant supply branch pipe (not shown) through an oxidant supply hole 23a disposed in a side surface of the lower casing 229b. The oxidant supply header 221 introduces the predetermined flow rate of the oxidizing gas, which is supplied from the oxidant supply branch pipe (not shown) via the oxidant supply hole 233a, to the power generation chamber 215 via an oxidant supply gap 235a described later.

The oxidant exhaust header 223 is an area surrounded by the upper casing 229a, the upper tube plate 225a, and the upper heat insulating body (support) 227a of the SOFC cartridge 203, and communicates with the oxidant exhaust branch pipe (not shown) through an oxidant exhaust hole 233b disposed in a side surface of the upper casing 229a. The oxidant exhaust header 223 introduces the exhaust oxidized gas, which is supplied to the oxidant exhaust header 223 via an oxidant exhaust gap 235b described later, from the power generation chamber 215 to the oxidant exhaust branch pipe (not shown) via the oxidant exhaust hole 233b.

The upper tube plate 225a is fixed to side plates of the upper casing 229a such that the upper tube plate 225a, a top plate of the upper casing 229a, and the upper heat insulating body 227a are substantially parallel to each other, between the top plate of the upper casing 229a and the upper heat insulating body 227a. Further, the upper tube plate 225a has a plurality of holes corresponding to the number of cell stacks 101 provided in the SOFC cartridge 203, and the cell stacks 101 are inserted into the holes, respectively. The upper tube plate 225a air-tightly supports one end of each of the plurality of cell stacks 101 via either or both of the sealing member 237a and an adhesive material, and isolates the fuel gas supply header 217 from the oxidant exhaust header 223.

The upper heat insulating body 227a is disposed at a lower end of the upper casing 229a such that the upper heat insulating body 227a, the top plate of the upper casing 229a, and the upper tube plate 225a are substantially parallel to each other, and is fixed to the side plates of the upper casing 229a. Further, the upper heat insulating body 227a has a plurality of holes corresponding to the number of cell stacks 101 provided in the SOFC cartridge 203. Each of the holes has a diameter which is set to be larger than the outer diameter of the cell stack 101. The upper heat insulating body 227a includes the oxidant exhaust gap 235b which is formed between an inner surface of the hole and an outer surface of the cell stack 101 inserted through the upper heat insulating body 227a.

The upper heat insulating body 227a separates the power generation chamber 215 and the oxidant exhaust header 223, and suppresses a decrease in strength or an increase in corrosion by an oxidizing agent contained in the oxidizing gas due to an increased temperature of the atmosphere around the upper tube plate 225a. The upper tube plate 225a or the like is made of a metal material having high temperature durability such as inconel, and thermal deformation is prevented which is caused by exposing the upper tube plate 225a or the like to a high temperature in the power generation chamber 215 and increasing a temperature difference in the upper tube plate 225a or the like. Further, the upper heat insulating body 227a introduces an exhaust oxidized gas, which has passed through the power generation chamber 215 and exposed to the high temperature, to the oxidant exhaust header 223 through the oxidant exhaust gap 235b.

According to the present embodiment, due to the structure of the SOFC cartridge 203 described above, the fuel gas and the oxidizing gas oppositely flow on the inner side and the outer side of the cell stack 101. Consequently, the exhaust oxidized gas exchanges heat with the fuel gas supplied to the power generation chamber 215 through the inside of the substrate tube 103, is cooled to a temperature at which the upper tube plate 225a or the like made of the metal material is not subjected to deformation such as buckling, and is supplied to the oxidant exhaust header 223. Further, the fuel gas is raised in temperature by the heat exchange with the exhaust oxidized gas exhausted from the power generation chamber 215 and supplied to the power generation chamber 215. As a result, the fuel gas, which is preheated and raised in temperature to a temperature suitable for power generation without using a heater or the like, can be supplied to the power generation chamber 215.

The lower tube plate 225b is fixed to side plates of the lower casing 229b such that the lower tube plate 225b, a bottom plate of the lower casing 229b, and the lower heat insulating body 227b are substantially parallel to each other, between the bottom plate of the lower casing 229b and the lower heat insulating body 227b. Further, the lower tube plate 225b has a plurality of holes corresponding to the number of cell stacks 101 provided in the SOFC cartridge 203, and the cell stacks 101 are inserted into the holes, respectively. The lower tube plate 225b air-tightly supports another end of each of the plurality of cell stacks 101 via either or both of the sealing member 237b and the adhesive material, and isolates the fuel gas exhaust header 219 from the oxidant supply header 221.

The lower heat insulating body 227b is disposed at an upper end of the lower casing 229b such that the lower heat insulating body 227b, the bottom plate of the lower casing 229b, and the lower tube plate 225b are substantially parallel to each other, and is fixed to the side plates of the lower casing 229b. Further, the lower heat insulating body 227b has a plurality of holes corresponding to the number of cell stacks 101 provided in the SOFC cartridge 203. Each of the holes has a diameter which is set to be larger than the outer diameter of the cell stack 101. The lower heat insulating body 227b includes the oxidant supply gap 235a which is formed between an inner surface of the hole and the outer surface of the cell stack 101 inserted through the lower heat insulating body 227b.

The lower heat insulating body 227b separates the power generation chamber 215 and the oxidant supply header 221, and suppresses the decrease in strength or the increase in corrosion by the oxidizing agent contained in the oxidizing gas due to an increased temperature of the atmosphere around the lower tube plate 225b. The lower tube plate 225b or the like is made of the metal material having high temperature durability such as inconel, and thermal deformation is prevented which is caused by exposing the lower tube plate 225b or the like to a high temperature and increasing a temperature difference in the lower tube plate 225b or the like. Further, the lower heat insulating body 227b introduces the oxidizing gas, which is supplied to the oxidant supply header 221, to the power generation chamber 215 through the oxidant supply gap 235a.

According to the present embodiment, due to the structure of the SOFC cartridge 203 described above, the fuel gas and the oxidizing gas oppositely flow on the inner side and the outer side of the cell stack 101. Consequently, the exhaust fuel gas having passed through the power generation chamber 215 through the inside of the substrate tube 103 exchanges heat with the oxidizing gas supplied to the power generation chamber 215, is cooled to a temperature at which the lower tube plate 225b or the like made of the metal material is not subjected to deformation such as buckling, and is supplied to the fuel gas exhaust header 219. Further, the oxidizing gas is raised in temperature by the heat exchange with the exhaust fuel gas and supplied to the power generation chamber 215. As a result, the oxidizing gas, which is raised to a temperature needed for power generation without using the heater or the like, can be supplied to the power generation chamber 215.

After being derived to the vicinity of the end of the cell stack 101 by a lead film 115 which is disposed in the plurality of single fuel cells 105 and is made of Ni/YSZ or the like, DC power generated in the power generation chamber 215 is collected to a power collector rod (not shown) of the SOFC cartridge 203 via a power collector plate (not shown), and is taken out of each SOFC cartridge 203. The DC power derived to the outside of the SOFC cartridge 203 by the power collector rod interconnects the generated powers of the respective SOFC cartridges 203 by a predetermined series number and parallel number, and is derived to the outside of the fuel cell module 210, is converted into predetermined AC power by a power conversion device (an inverter or the like) such as a power conditioner (not shown), and is supplied to a power supply destination (for example, a load system or a utility grid).

As shown in FIG. 3, the cell stack 101 includes the cylindrical-shaped substrate tube 103 as an example, the plurality of single fuel cells 105 formed on an outer circumferential surface of the substrate tube 103, and an interconnector 107 formed between the adjacent single fuel cells 105. Each of the single fuel cells 105 is formed by laminating a fuel-side electrode 109, an electrolyte 111, and an oxygen-side electrode 113. Further, the cell stack 101 includes the lead film 115 electrically connected via the interconnector 107 to the oxygen-side electrode 113 of the single fuel cell 105 formed at farthest one end of the substrate tube 103 in the axial direction and includes the lead film 115 electrically connected to the fuel-side electrode 109 of the single fuel cell 105 formed at farthest another end, among the plurality of single fuel cells 105 formed on the outer circumferential surface of the substrate tube 103.

The substrate tube 103 is made of a porous material and includes, for example, CaO stabilized ZrO₂ (CSZ), a mixture (CSZ+NiO) of CSZ and nickel oxide (NiO), or Y₂O₃ stabilized ZrO₂ (YSZ), MgAl₂O₄ or the like as a main component. The substrate tube 103 supports the single fuel cells 105, the interconnector 107, and the lead film 115, and diffuses the fuel gas supplied to an inner circumferential surface of the substrate tube 103 to the fuel-side electrode 109 formed on the outer circumferential surface of the substrate tube 103 via a pore of the substrate tube 103.

The fuel-side electrode 109 is composed of an oxide of a composite material of Ni and a zirconia-based electrolyte material and, for example, Ni/YSZ is used. The fuel-side electrode 109 has a thickness of 50 μm to 250 μm, and the fuel-side electrode 109 may be formed by screen-printing a slurry. In this case, in the fuel-side electrode 109, Ni which is the component of the fuel-side electrode 109 has catalysis on the fuel gas. The catalysis reacts the fuel gas supplied via the substrate tube 103, for example, a mixed gas of methane (CH₄) and water vapor to be reformed into hydrogen (H₂) and carbon monoxide (CO). Further, the fuel-side electrode 109 electrochemically reacts hydrogen (H₂) and carbon monoxide (CO) obtained by the reformation with oxygen ions (O²⁻) supplied via the electrolyte 111 in the vicinity of the interface with the electrolyte 111 to produce water (H₂O) and carbon dioxide (CO₂). At this time, the single fuel cell 105 generate power by electrons emitted from oxygen ions.

The fuel gas, which can be supplied to and used for the fuel-side electrode 109 of the solid oxide fuel cell, includes, for example, a gasification gas produced from petroleum, methanol, and a carbon-containing raw material such as coal by a gasification facility, in addition to hydrogen (H₂) and hydrocarbon-based gas of carbon monoxide (CO), methane (CH₄), or the like, city gas, or natural gas.

As the electrolyte 111, YSZ is mainly used which has a gas-tight property that makes it difficult for a gas to pass through and a high oxygen ion conductive property at high temperature. The electrolyte 111 moves the oxygen ions (O²⁻) generated in the oxygen-side electrode to the fuel-side electrode. The electrolyte 111 located on a surface of the fuel-side electrode 109 has a film thickness of 10 μm to 100 μm, and the electrolyte 111 may be formed by screen-printing the slurry.

The oxygen-side electrode 113 is composed of, for example, LaSrMnO₃-based oxide or LaCoO₃-based oxide, and the oxygen-side electrode 113 is coated with the slurry by using screen-printing or a dispenser. The oxygen-side electrode 113 dissociates oxygen in the oxidizing gas such as supplied air to generate oxygen ions (O²⁻), in the vicinity of the interface with the electrolyte 111.

The oxygen-side electrode 113 can also have a two-layer structure. In this case, the oxygen-side electrode layer (oxygen-side electrode intermediate layer) on the electrolyte 111 side is made of a material which shows a high ion conductive property and is excellent in catalytic activity. The oxygen-side electrode layer (oxygen-side electrode conductive layer) on the oxygen-side electrode intermediate layer may be composed of a perovskite-type oxide represented by Sr and Ca-doped LaMnO₃. Thus, it is possible to further improve power generation performance.

The oxidizing gas is a gas containing approximately 15% to 30% of oxygen, and air is representatively suitable. Besides air, however, a mixed gas of a combustion exhaust gas and air, a mixed gas of oxygen and air, or the like can be used.

The interconnector 107 is composed of a conductive perovskite-type oxide represented by M₁₋ₓLₓTiO₃ (M is an alkaline earth metal element, L is a lanthanoid element) such as SrTiO₃ system, and screen-prints the slurry. The interconnector 107 has a dense film so that the fuel gas and the oxidizing gas do not mix with each other. Further, the interconnector 107 has stable durability and electrical conductivity under both an oxidizing atmosphere and a reducing atmosphere. In the adjacent single fuel cells 105, the interconnector 107 electrically connects the oxygen-side electrode 113 of the one single fuel cell 105 and the fuel-side electrode 109 of another single fuel cell 105, and connects the adjacent single fuel cell cells 105 to each other in series.

The lead film 115 needs to have electron conductivity and a thermal expansion coefficient close to that of another material composing the cell stack 101, and is thus composed of a composite material of a zirconia-based electrolyte material and Ni such as Ni/YSZ or M₁₋ₓLxTiO3 (M is an alkaline earth metal element, L is a lanthanoid element) such as SrTiO₃ system. The lead film 115 derives the DC power which is generated in the plurality of single fuel cells 105 connected in series by the interconnector 107 to the vicinity of the end of the cell stack 101.

In some embodiments, instead of separately providing the fuel-side electrode or the oxygen-side electrode and the substrate tube as described above, the fuel-side electrode or the oxygen-side electrode may thickly be formed to also serve as the substrate tube. Further, although the substrate tube in the present embodiment is described with the substrate tube having the cylindrical shape, a cross section of the substrate tube is not necessarily limited to a circular shape but may be, for example, an elliptical shape, as long as the substrate tube has a tubular shape. A cell stack may be used which has, for example, a flat tubular shape obtained by vertically squeezing a circumferential side surface of the cylinder.

(Configuration of Fuel Cell Power Generation System)

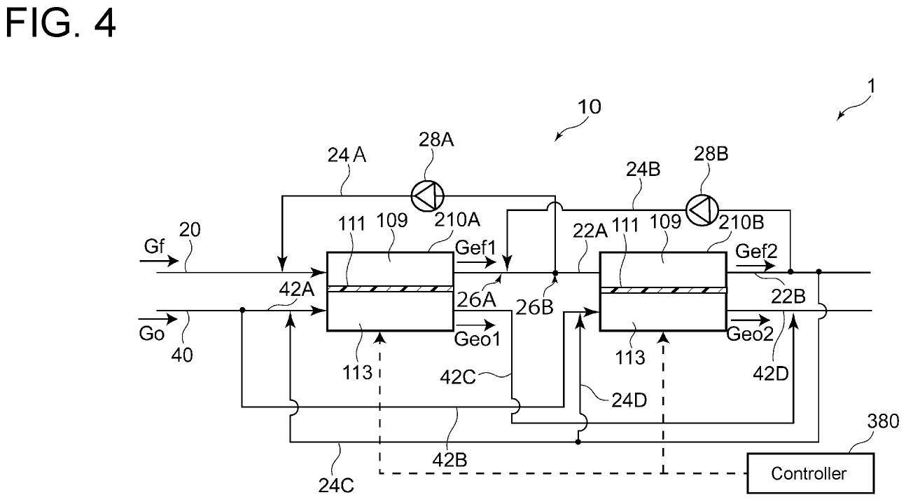

Next, a fuel cell power generation system 1 that uses the fuel cell module 210 having the above configuration will be described. FIG. 4 is a schematic configuration diagram of the fuel cell power generation system 1 according to an embodiment.

As shown in FIG. 4, the fuel cell power generation system 1 includes a fuel cell part 10 including a first fuel cell module 210A and a second fuel cell module 210B, a fuel gas supply line 20 for supplying a fuel gas Gf to the fuel cell part 10, a first exhaust fuel gas line 22A through which a first exhaust fuel gas Gef1 exhausted from the first fuel cell module 210A flows, a second exhaust fuel gas line 22B through which a second exhaust fuel gas Gef2 exhausted from the second fuel cell module 210B flows, an oxidant supply line 40 for supplying an oxidizing gas Go to the fuel cell part 10, a first exhaust oxidized gas line 42A through which a first exhaust oxidized gas Geo1 exhausted from the first fuel cell module 210A flows, and a second exhaust oxidized gas line 42B through which a second exhaust oxidized gas Geo2 from the second fuel cell module 210B flows.

The oxidant supply line 40 may be provided with a booster (not shown) for increasing the pressure of the oxidizing gas Go supplied to the fuel cell part 10. The booster is, for example, a compressor or a recirculation blower.

The first fuel cell module 210A and the second fuel cell module 210B are provided with at least one fuel cell cartridge 203 as described above, and the fuel cell cartridge 203 may be composed of the plurality of cell stacks 101 each including the plurality of single fuel cells 105 (see FIGS. 1 and 2). Each of the single fuel cells 105 includes the fuel-side electrode 109, the electrolyte 111, and the oxygen-side electrode 113 (see FIG. 3).

In FIG. 4, the fuel cell part 10 is configured such that by connecting the first fuel cell module 210A and the second fuel cell module 210B in series (cascade) to the fuel gas supply line 20, the first exhaust fuel gas Gef1 exhausted from the first fuel cell module 210A in the preceding stage is supplied to the second fuel cell module 210B in the subsequent stage via the first exhaust fuel gas line 22A. Further, a part of the first exhaust fuel gas Gef1 flowing through the first exhaust fuel gas line 22A is supplied to a fuel gas inlet of the first fuel cell module 210A via a second recirculation line 24A by a first recirculation gas recirculation blower 28A. The second exhaust fuel gas Gef2 from the second fuel cell module 210B in the subsequent stage is exhausted to the outside via the second exhaust fuel gas line 22B. Further, a part of the second exhaust fuel gas Gef2 flowing through the second exhaust fuel gas line 22B may be supplied to a fuel gas inlet of the second fuel cell module 210B via a first recirculation line 24B by a second recirculation gas recirculation blower 28B.

In the present embodiment, the case is exemplified in which two fuel cell modules are connected in series (cascade) to the fuel gas supply line 20. However, any number of (not less than 3) fuel cell modules may be connected in series (cascade).

Further, FIG. 4 exemplifies a case where the first fuel cell module 210A and the second fuel cell module 210B are connected in parallel to the oxidant supply line 40. That is, the first fuel cell module 210A in the preceding stage and the second fuel cell module 210B in the subsequent stage are configured to individually be supplied with air from the oxidant supply lines 42A and 42B branched upstream. The first exhaust oxidized gas Geo1 from the first fuel cell module 210A in the preceding stage is exhausted to the outside via a first exhaust oxidized gas line 42C, and the second exhaust oxidized gas Geo2 from the second fuel cell module 210B in the subsequent stage is exhausted to the outside via a second exhaust oxidized gas line 42D.

In another embodiment, the oxidant supply line 40 may be connected in series (cascade) to the first fuel cell module 210A and the second fuel cell module 210B composing the fuel cell part 10. That is, part or all of the first exhaust oxidized gas Geo1 from the first fuel cell module 210A may be supplied to the second fuel cell module 210B.

The fuel gas supply line 20 corresponds to the fuel gas supply pipe 207 shown in FIG. 1, and the first exhaust fuel gas line 22A is connected to the fuel gas exhaust pipe 209 shown in FIG. 1. Further, the second exhaust fuel gas line 22B is connected to the fuel gas exhaust pipe 209 of the second fuel cell module shown in FIG. 1.

The oxidant supply line 42A, 42B corresponds to an oxidant supply pipe (not shown in FIG. 1), and the first exhaust oxidized gas line 42C is connected to an oxidant exhaust pipe (not shown in FIG. 1). Further, the second exhaust oxidized gas line 42D corresponds to an oxidant exhaust pipe (not shown in FIG. 1).

The fuel cell power generation system 1 includes the first recirculation line 24B recirculating from the second exhaust fuel gas line 22B. The first recirculation line 24B is connected to the first exhaust fuel gas line 22A, and is configured to supply the second exhaust fuel gas Gef2 from the second fuel cell module 210B to the upstream side of the second fuel cell module 210B (that is, the first recirculation line 24B is configured to circulate and supply the second exhaust fuel gas Gef2 to the second fuel cell module 210B).

Thus, regardless of the operating state of the first fuel cell module 210A in the preceding stage, by controlling a recycle supply amount from the second exhaust fuel gas Gef2 via the first recirculation line 24B, it is possible to appropriately secure steam necessary to reform the fuel gas supplied to the second fuel cell module 210B. Thus, regardless of the operating state of the first fuel cell module 210A, the operating state of the second fuel cell module 210B can be stabilized even if a required system load Ls changes.

The first recirculation line 24B may be provided with a valve for controlling the flow rate of the second exhaust fuel gas Gef2 flowing through the first recirculation line 24B. In this case, the opening degree of the valve can be controlled by a controller 380 to be described later.

Further, the fuel cell power generation system 1 includes the second recirculation line 24A recirculating from the first exhaust fuel gas line 22A. The second recirculation line 24A is connected to the fuel gas supply line 20, and is configured to supply the first exhaust fuel gas Gef1 from the first fuel cell module 210A to the upstream side of the first fuel cell module 210A (that is, the second recirculation line 24A is configured to circulate and supply the first exhaust fuel gas Gef1 to the first fuel cell module 210A). Thus, by controlling the supply amount of the first exhaust fuel gas Gef1 via the second recirculation line 24A, it is possible to appropriately secure moisture necessary to reform the fuel gas in the first fuel cell module 210A.

The second recirculation line 24A may be provided with a valve for controlling the flow rate of the first exhaust fuel gas Gef1 flowing through the second recirculation line 24A. In this case, the opening degree of the valve can be controlled by the controller 380 to be described later.

A first confluent portion 26A with the first recirculation line 24B is disposed, in the first exhaust fuel gas line 22A, upstream of a second branch portion 26B from the second recirculation line 24A. Thus, even if the first fuel cell module 210A is in a non-power generation (hot standby) state, it is possible to supply the steam generated by the power generation of the second fuel cell module 210B to the first fuel cell module 201A.

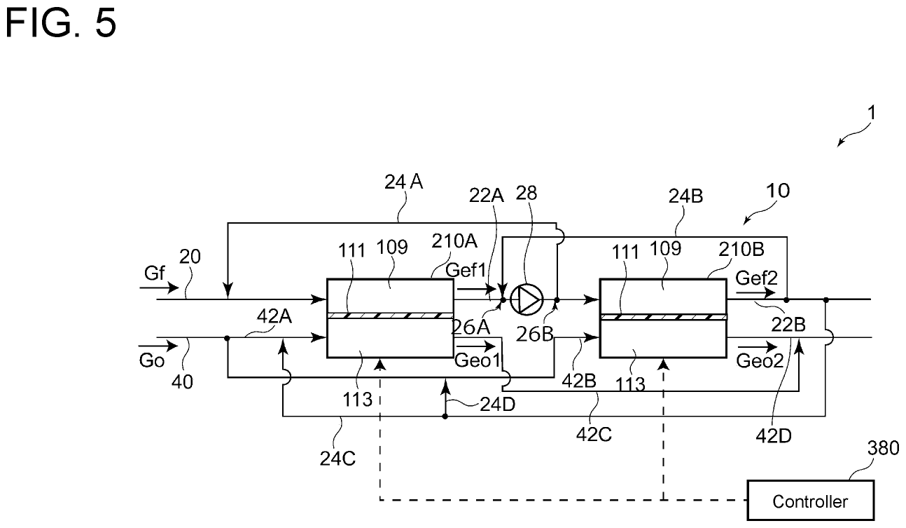

FIG. 5 is a schematic configuration diagram of the fuel cell power generation system 1 according to another embodiment. In FIG. 5, the configurations corresponding to those in FIG. 4 are associated with the same reference signs and redundant description will be omitted as appropriate, unless particularly stated otherwise.

As shown in FIG. 5, in another embodiment, the recirculation blower 28 may be provided, in the first exhaust fuel gas line 22A, between the first confluent portion 26A with the first recirculation line 24B and the second branch portion 26B from the second recirculation line 24A. The recirculation blower 28 is disposed upstream of the second branch portion 26B, thereby circulating and supplying the first exhaust fuel gas Gef1 to the first fuel cell module 210A via the second recirculation line 24A. Further, the recirculation blower 28 is disposed downstream of the first confluent portion 26A thereby applying a negative pressure to the first recirculation line 24B, and circulating and supplying the second exhaust fuel gas Gef2 to the second fuel cell module 210B via the first recirculation line 24B. With the one recirculation blower 28 thus disposed on the first exhaust fuel gas line 22A, it is possible to realize the circulation and supply of the fuel gas in the second fuel cell module 210B and the second fuel cell module 210B via the first recirculation line 24B and the second recirculation line 24A described above (that is, the system configuration can be simplified by reducing the number of recirculation blowers compared to the case where the recirculation blowers are disposed on the first recirculation line 24B and the second recirculation line 24A, respectively).

Further, the fuel cell power generation system 1 includes a second exhaust fuel gas supply line 24C connecting the second exhaust fuel gas line 22B and the oxidant supply line 42A such that the second exhaust fuel gas Gef2 can be supplied to the oxidant supply line 42A of the first fuel cell module 210A. The oxygen-side electrode 113 of the single fuel cell has the function of acting as a catalyst in catalytic combustion reaction between the fuel component and oxygen. According to the above-described embodiment, since the second exhaust fuel gas Gef2 from the second fuel cell module 210B is supplied to the oxygen-side electrode 113 of the first fuel cell module 210A, the unused fuel component contained in the exhaust fuel gas is appropriately burned by utilizing the catalytic action of the oxygen-side electrode 113, making it possible to maintain a predetermined temperature even if the first fuel cell module is in the non-power generation (hot standby) state.

The above will be described in more detail. In the solid oxide fuel cell, the temperature of the power generation chamber 215 during operation is a high temperature of approximately 600° C. to 1,000° C., and the high-temperature state is autonomously maintained by the heat generated due to power generation. However, the non-power generation (hot standby) state is entered due to the decrease in the required system load Ls, for example, the temperature decreases as the power generation reaction stops. Therefore, when the required system load Ls increases again and power generation is resumed, the temperature of the power generation chamber 215 has to be raised to a temperature enabling power generation, and it is difficult to quickly follow the change in the required system load Ls.

To address such problem, in the present embodiment, even if the first fuel cell module 210A is in the non-power generation (hot standby) state, since the second exhaust fuel gas Gef2 from the second fuel cell module 210B is supplied to the oxygen-side electrode 113 of the first fuel cell module 210A via the second exhaust fuel gas supply line 24C and burned, the power generation chamber 215 of the first fuel cell module 210A can be maintained at the temperature necessary for power generation. Thus, the first fuel cell module 210A in the non-power generation (hot standby) state can quickly be switched to the power generation state, obtaining good load response performance. Further, the temperature in such non-power generation (hot standby) state can be maintained without adding extra fuel gas to the first fuel cell module 210A from the outside, which suppresses energy consumption and is effective in improving the system power generation efficiency in case the required system load decreases.

The temperature of the power generation chamber 215 in the non-power generation (hot standby) state is, for example, approximately 600° C. to 900° C.

The supply of the second exhaust fuel gas Gef2 to the first fuel cell module 210A via the second exhaust fuel gas supply line 24C may be performed, in addition to the case where the first fuel cell module 210A is maintained in the non-power generation (hot standby) state as described above, in a case where combustion consumption is performed in the first fuel cell module 210A in order not to exhaust the unused fuel component (hydrogen, CO, methane, etc.) contained in the second exhaust fuel gas Gef2 to the outside. This case is advantageous in that it is possible to simplify the exhaust gas treatment device for treating the unused fuel component contained in the second exhaust fuel gas Gef2.

Further, the third recirculation line 24C may be provided with a valve for controlling the flow rate of the second exhaust fuel gas Gef2 flowing through the third recirculation line 24C. In this case, the opening degree of the valve can be controlled by the controller 380 to be described later.

Further, the fuel cell power generation system 1 further includes a second exhaust fuel gas supply line 24D connecting the second exhaust fuel gas line 22B and the oxidant supply line 42B such that the second exhaust fuel gas Gef2 can be supplied to the oxidant supply line 42B of the second fuel cell module 210B. The oxygen-side electrode 113 of the single fuel cell may have a structure for acting as the catalyst in the catalytic combustion reaction between the fuel component and oxygen. According to the above-described embodiment, since the second exhaust fuel gas Gef2 from the second fuel cell module 210B is supplied to the oxygen-side electrode 113 of the second fuel cell module 210B, the unused fuel component contained in the exhaust fuel gas is appropriately burned by utilizing the catalytic action of the oxygen-side electrode 113, making it possible to maintain the predetermined temperature even if the second fuel cell module is in the non-power generation (hot standby) state or in the minimum load operation state.

In the present embodiment, even if the second fuel cell module 210B is in the non-power generation (hot standby) state or in the minimum load operation state, since the second exhaust fuel gas Gef2 from the second fuel cell module 210B is supplied to the oxygen-side electrode 113 of the second fuel cell module 210B via the second exhaust fuel gas supply line 24D and burned, the power generation chamber 215 of the second fuel cell module 210B can be maintained at the temperature necessary for power generation. Thus, the second cell module 210B in the non-power generation (hot standby) state can quickly be switched to the power generation state, obtaining good load response performance. Further, the temperature in such non-power generation (hot standby) or the minimum load state can be maintained without adding extra fuel gas to the second fuel cell module 210A from the outside, which suppresses fuel consumption and is effective in improving the system power generation efficiency in case the required system load decreases.

Further, the second exhaust fuel gas supply line 24D may be provided with a valve for controlling the flow rate of the second exhaust fuel gas Gef2 flowing through the second exhaust fuel gas supply line 24D. In this case, the opening degree of the valve can be controlled by the controller 380 to be described later.

Further, the fuel cell power generation system 1 includes a controller 380 for controlling each component of the fuel cell power generation system 1. The controller 380 includes, for example, a Central Processing Unit (CPU), a Random Access Memory (RAM), a Read Only Memory (ROM), a computer-readable storage medium, and the like. Then, a series of processes for realizing various functions is stored in the storage medium or the like in the form of a program, as an example. The CPU reads the program out to the RAM or the like and executes processing/calculation of information, thereby realizing the various functions. The program may be applied with a configuration where the program is installed in the ROM or another storage medium in advance, a configuration where the program is provided in a state of being stored in the computer-readable storage medium, a configuration where the program is distributed via a wired or wireless communication means, or the like. The computer-readable storage medium is a magnetic disk, a magneto-optical disk, a CD-ROM, a DVD-ROM, a semiconductor memory, or the like.

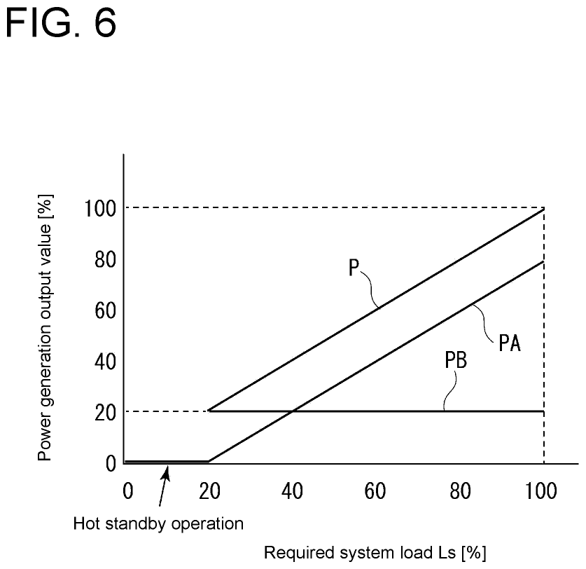

Herein, the control contents of the fuel cell power generation system 1 by the controller 380 will be described with reference to FIGS. 6 to 8. The control contents show one embodiment and does not define the control method.

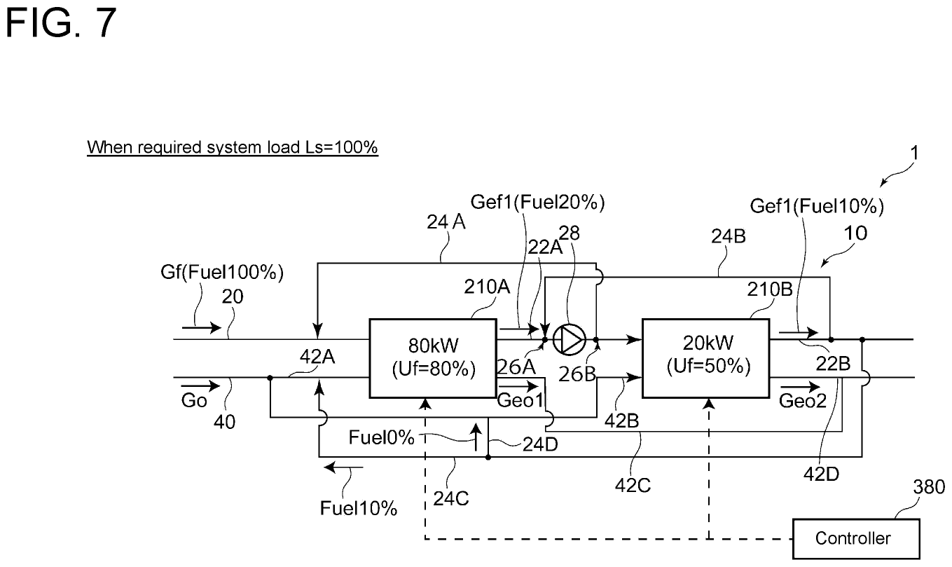

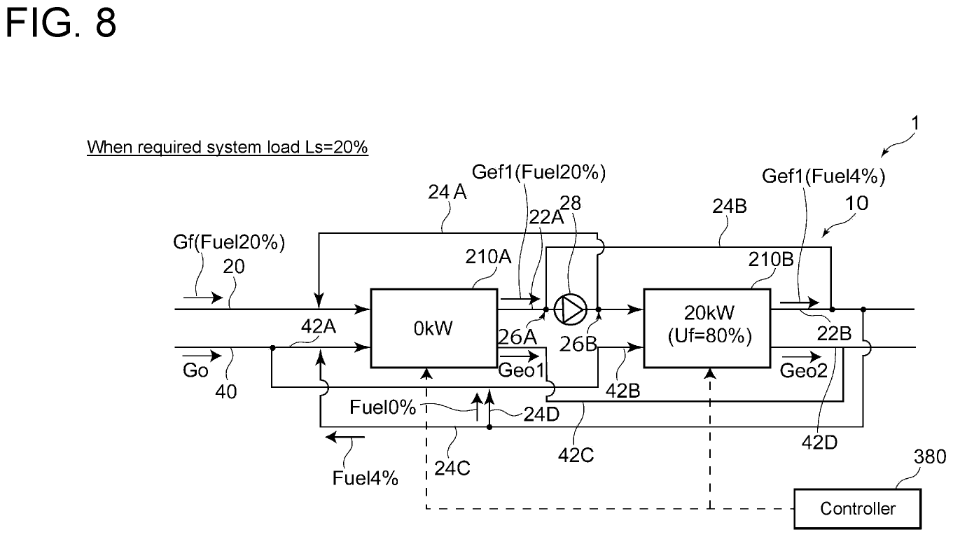

FIG. 6 is a graph showing the relationship between the required system load Ls and a power generation output value with respect to the fuel cell power generation system 1 shown in FIG. 4. FIG. 7 is a diagram showing the operating state of the fuel cell power generation system 1 of FIG. 4 when the required system load Ls is 100%. FIG. 8 is a diagram showing the operating state of the fuel cell power generation system 1 of FIG. 4 when the required system load Ls is 20%.

FIG. 6 shows a power generation output value P of the entire system of the fuel cell power generation system 1, a power generation output value PA of the first fuel cell module 210A, and a power generation output value PB of the second fuel cell module in respective percentages relative to the rated output of the entire system.

The controller 380 controls the first fuel cell module 210A and the second fuel cell module 210B based on the required system load Ls. The required system load Ls is a parameter which is commanded from outside the fuel cell power generation system 1 and varies based on power demand for the fuel cell power generation system 1. For example, the required system load Ls changes according to the power generation status of another power generation system (renewable energy power generation system) connected to the power grid which is a power supply destination of the fuel cell power generation system 1 or power demand for the power grid. The controller 380 controls the operating states of the first fuel cell module 210A and the second fuel cell module 210B, respectively, based on such required system load Ls, thereby adjusting the power generation output value P of the entire system so as correspond to the required system load Ls.

Herein, in a typical fuel cell cascade power generation system, the fuel according to the required system load Ls is supplied to the first fuel cell module 210A and in the second fuel cell module 210B, power generation is performed according to the unused fuel which is contained in the first exhaust fuel gas Gef1 exhausted from the first fuel cell module 210A. Therefore, the ratio of the power generation output by the first fuel cell module 210A and the second fuel cell module 210B is substantially constant regardless of the required system load Ls. For example, if the ratio of the rated output values of the first fuel cell module 210A and the second fuel cell module 210B is 8:2, 80% of the required system load Ls is distributed to the first fuel cell module 210A and the remaining 20% is distributed to the second fuel cell module 210B.

Meanwhile, in the present embodiment, as shown in FIG. 6, while the controller 380 variably controls the output PA of the first fuel cell module 210A according to the required system load Ls, the controller 380 controls the output PB of the second fuel cell module 210B to be a preset substantially constant output. That is, the power generation output value PB of the second fuel cell module 210B in the subsequent stage is controlled to the substantially constant target value regardless of the required system load Ls, and the change in the required system load Ls is addressed by controlling the operating state of the first fuel cell module 210A in the preceding stage. Thus, since the power generation output value PB of the second fuel cell module 210B is controlled to substantially be constant regardless of the required system load Ls, even if the required system load Ls changes, the second fuel cell module 210B in the subsequent stage having the smaller rated output than the first fuel cell module generates power at the substantially constant output and the temperature of the power generation chamber is maintained, minimizing the influence on the required system load Ls and making it possible to improve the load response performance of the system.

The constant target value of the power generation output value PB of the second fuel cell module 210B is set to, for example, the rated output value of the second fuel cell module 210B. Thus, the second fuel cell module 210B can perform rated operation regardless of the required system load Ls, enabling efficient power generation. Thus, even if the required system load Ls changes, it is possible to achieve good system efficiency while stabilizing the operating state of the second fuel cell module 210B in the subsequent stage.

In the present embodiment, the rated output value of the second fuel cell module 210B is smaller than the rated output value of the first fuel cell module 210A. Thus, since the second fuel cell module 210B has the smaller heat generation amount associated with the power generation than the first fuel cell module 210A and also has the smaller heat capacity than the first fuel cell module 210A, it is difficult to always maintain the temperature of the power generation chamber at the proper temperature for the required system load Ls. However, as described above, since the power generation output value PB of the second fuel cell module 210B is controlled to be the constant target value, it becomes easier to maintain the proper temperature and the stable system operation is possible even if the required system load Ls changes or during partial load operation.

FIGS. 7 and 8 show, as an example, a case where the overall rated output value of the fuel cell power generation system 1 is 100 kW, the rated output value of the first fuel cell module 210A is 80 kW, and the rated output value of the second fuel cell module 210B is 20 kW. As shown in FIG. 7, in the case where the required system load Ls is 100% (that is, 100 kW), if the fuel gas Gf flowing through the fuel gas supply line 20 is 100, in the first fuel cell module 210A in the preceding stage, 80% of the fuel gas Gf is consumed with a fuel utilization rate Uf=80% and the remaining 20% is exhausted as the first exhaust fuel gas Gef1. The first exhaust fuel gas Gef1 is supplied to the second fuel cell module 210B in the subsequent stage. In the second fuel cell module 210B, 50% of the first exhaust fuel gas Gef1 is consumed with the fuel utilization rate Uf=50%, and the remaining 10% is exhausted as the second exhaust fuel gas Gef2, resulting in the fuel utilization rate of the entire system being 90%.

The 10% second exhaust fuel gas Gef2 may directly be exhausted to the outside, but in FIG. 7, by supplying the second exhaust fuel gas Gef2 to the oxidant supply line 42A of the first fuel cell module 210A via the second exhaust fuel gas supply line 24C, the unused fuel component contained in the second exhaust fuel gas Gef2 is burned and then exhausted to the outside.

Further, if the required system load Ls is not greater than the rated output value of the second fuel cell module 210B (for example, on the occurrence of surplus power by the renewable energy power generation system connected to the power grid which is the power supply destination of the fuel cell power generation system 1 or at night when power demand is low), the controller 380 can reduce the output of the first fuel cell module 210A to the minimum load operation necessary to suppress carbon deposition due to the input fuel. In this case, the temperature maintenance of the first fuel cell module 210A is realized by supplying the second exhaust fuel gas Gef2 to the oxygen-side electrode 113 of the first fuel cell module 210A via the second exhaust fuel gas supply line 24C and burning the second exhaust fuel gas Gef2, as described above. In the minimum load operation state of the first fuel cell module 210A, the steam contained in the exhaust fuel gas of the second fuel cell module 210B, which is operating reforming steam at the rated load, is supplied to the fuel supply line 20 of the first fuel cell module 210A by the recirculation blower 28, enabling the operation with a lower load or no load. In this case as well, since the first fuel cell module 210A is maintained at the temperature necessary for the operation of the fuel cell or at the temperature close to said temperature, when the required system load Ls increases in the future, power generation by the first fuel cell module 210A is resumed and good load followability is obtained while avoiding energy consumption associated with the start/stop of the first fuel cell module 210A.

FIG. 8 shows the operating state of the fuel cell power generation system 1 in the case where the required system load Ls is 20%, the first fuel cell module 210A is in the no-load operation (hot standby) state, and the rated output value of the second fuel cell module 210B is 20 kW as an example of the partial load operation. In this case, assuming that the fuel gas Gf flowing through the fuel gas supply line 20 is 20, the first fuel cell module 210A in the preceding stage is controlled to be in the no-load operation (hot standby) state, and steam necessary to prevent carbon deposition is supplied with the second exhaust fuel gas Gef2 from the second fuel module 210B via the first recirculation gas line 24B and the second recirculation gas line 24B. In the second fuel cell module 210B, 80% of the fuel gas Gf supplied to the first fuel cell is consumed with the fuel utilization rate Uf=80%, and if the rating of the required system load Ls is 100, 4% of fuel is exhausted as the second exhaust fuel gas Gef2. The 4% second exhaust fuel gas Gef2 is supplied to the oxygen-side electrode 113 of the first fuel cell module 210A via the second exhaust fuel gas supply line 24C, thereby being used to maintain the temperature in the no-load operation (hot standby) state of the first fuel cell module 210A.

Further, if the required system load Ls decreases below the rated output value of the second fuel cell module 210B (for example, on the occurrence of surplus power by the renewable energy power generation system connected to the power grid which is the power supply destination of the fuel cell power generation system 1 or at night when power demand is low), the controller 380 may further control, in addition to the first fuel cell module 210A, the second fuel cell module 210B to enter the low-load operation state. At this time, the first fuel cell module 210A is controlled to be in the no-load operation (hot standby) state, and the second fuel cell module 210B is controlled to be in the low-load operation state. The no-load operation (hot standby) state of the first fuel cell module 210A is realized by supplying the second exhaust fuel gas Gef2 to the oxygen-side electrode 113 of the first fuel cell module 210A via the second exhaust fuel gas supply line 24C and burning the second exhaust fuel gas Gef2, as described above. Further, the low-load operation state of the second fuel cell module 210B is realized by supplying the second exhaust fuel gas Gef2 to the oxygen-side electrode 113 of the second fuel cell module 210B via the fourth recirculation line 24D and burning the second exhaust fuel gas Gef2, as described above.

In the low-load operation state, since steam is supplied which is necessary to prevent carbon deposition due to the power generation in the second fuel cell module 210B, the fuel cell module is maintained at the temperature necessary for the operation of the fuel cell or at the temperature close to said temperature, and the fuel supply system or the fuel recirculation system continues the operation, when the required system load increases in the future, power generation by each fuel cell module is resumed in a short time and good load followability is obtained while avoiding energy consumption associated with the start/stop of the fuel cell module.

If the first fuel cell module 210A is controlled to be in the no-load operation (hot standby) state and the second fuel cell module 210B is controlled to be in the low-load operation state as described above, the controller 380 may control the second fuel cell module 210B such that station service power for maintaining the fuel cell power generation system 1 in the no-load operation (hot standby) state is generated. In this case, the second fuel cell module 210B performs minimum power generation such that station service power necessary to maintain the fuel cell power generation system 1 in the no-load operation (hot standby) state or its own minimum load operation state is generated. Thus, when the required system load Ls increases in the future, power generation can quickly be resumed in each fuel cell module and good load followability is obtained while avoiding energy consumption associated with the start/stop of the fuel cell module.

Further, the system as a whole can be kept in a state of being able to generate power at all times with minimum fuel without being supplied with power from the outside (system), and the operability as an independent power source is improved.

As described above, according to each embodiment described above, it is possible to provide the fuel cell power generation system 1 having the stable operating state and capable of achieving good load followability and system efficiency in the fuel cell power generation system 1 that includes the plurality of fuel cell modules connected in series (cascade) with respect to the flow of the fuel gas.

The contents described in the above embodiments would be understood as follows, for instance.

(1) A fuel cell power generation system according to an aspect includes: a first fuel cell module (such as the first fuel cell module 210A of the above-described embodiment) capable of generating power with a fuel gas (such as the fuel gas Gf1 of the above-described embodiment); a first exhaust fuel gas line (such as the first exhaust fuel gas line 22A of the above-described embodiment) through which a first exhaust fuel gas (such as the first exhaust fuel gas Gef1 of the above-described embodiment) exhausted from the first fuel cell module flows; a second fuel cell module (such as the second fuel cell module 210B of the above-described embodiment) capable of generating power with the first exhaust fuel gas; a second exhaust fuel gas line (such as the second exhaust fuel gas line 22B of the above-described embodiment) through which a second exhaust fuel gas (such as the second exhaust fuel gas Gef2 of the above-described embodiment) exhausted from the second fuel cell module flows; and a first recirculation line (such as the first recirculation line 24B of the above-described embodiment) recirculating from the second exhaust fuel gas line in order to supply the second exhaust fuel gas to a fuel-side electrode of the second fuel cell module.

With the above aspect (1), in the fuel cell power generation system in which the first fuel cell module and the second fuel cell module are connected in series (cascade) with respect to the flow of the fuel gas, it is configured such that the second exhaust fuel gas exhausted from the second fuel cell module can be supplied to the fuel-side electrode of the second fuel cell module via the first recirculation line. Thus, regardless of the operating state of the first fuel cell module, by controlling the supply amount of the second exhaust fuel gas via the first recirculation line, it is possible to appropriately secure moisture necessary to reform the fuel gas in the second fuel cell module. Thus, regardless of the operating state of the first fuel cell module, the operating state of the second fuel cell module can be stabilized even if a required system load changes.

(2) In another aspect, in the above aspect (1), the fuel cell power generation system further includes: a second recirculation line recirculating from the first exhaust fuel gas line in order to supply the first exhaust fuel gas to a fuel-side electrode of the first fuel cell module. The first recirculation line is connected so as to join the first exhaust fuel gas line upstream of a branch portion from the second recirculation line.

With the above aspect (2), even if the first fuel cell module is in a non-power generation (hot standby) state, it is possible to supply the steam generated by the power generation of the second fuel cell module to the first fuel cell module.

(3) In another aspect, in the above aspect (2), each of the first recirculation line and the second recirculation line is provided with a recirculation blower.

With the above aspect (3), it is possible to independently control the circulation amounts in the first recirculation line and the second recirculation line.

(4) In another aspect, in the above aspect (2), a recirculation blower (such as the recirculation blower 28 of the above-described embodiment) for pumping the first exhaust fuel gas is provided, in the first exhaust fuel gas line, between a first confluent portion (such as the first confluent portion 26A of the above-described embodiment) with the first recirculation line and a second branch portion (such as the second branch portion 26B of the above-described embodiment) from the second recirculation line.

With the above aspect (4), since the recirculation blower is provided at the above-described position of the first exhaust fuel gas line, the second exhaust fuel gas can be supplied to the fuel-side electrode of the first fuel cell module via the second recirculation line and the second exhaust fuel gas can be supplied to the fuel-side electrode of the second fuel cell module via the first recirculation line.

(5) In another aspect, in any one of the above aspects (1) to (4), the fuel cell power generation system includes: a controller (such as the controller 380 of the above-described embodiment) for controlling the first fuel cell module and the second fuel cell module based on a required system load (such as the required system load Ls of the above-described embodiment). The controller variably controls an output of the first fuel cell module according to the required system load, and controls an output of the second fuel cell module to a preset constant target value regardless of the required system load.

With the above aspect (5), if the required system load changes, the output of the second fuel cell module is maintained at the constant target value, whereas the output of the first fuel cell module is variably controlled, thereby following the required system load. Thus, since the output of the second fuel cell module is controlled to the constant target value regardless of the required system load, even if the required system load changes, it is possible to improve the load response performance of the system while maintaining the stable operating state of the second fuel cell module.

(6) In another aspect, in the above aspect (5), the constant target value is substantially a rated output value of the second fuel cell module.

With the above aspect (6), the output of the second fuel cell power generation module is maintained substantially at the rated output value regardless of the required system load. Thus, even if the required system load changes, the operating state of the second fuel cell module is stabilized, and it is possible to achieve good power generation efficiency.

(7) In another aspect, in the above aspect (5) or (6), a rated output value of the second fuel cell module is smaller than a rated output value of the first fuel cell module.

With the above aspect (7), since the second fuel cell module has the smaller rated output value than the first fuel cell module, the heat generation amount associated with power generation is small. In such system, since the second fuel cell module has the smaller heat generation amount than the first fuel cell module and the heat capacity of the fuel cell module is small, it is difficult to maintain the proper temperature during the change in load or during the partial load. However, as described above, since the output of the second fuel cell module is controlled to be the constant target value, it becomes easier to maintain the proper temperature and the stable system operation is possible even if the required system load changes or during partial load operation.

(8) In another aspect, in any one of the above aspects (5) to (7), the controller controls the first fuel cell module to enter a no-load operation (hot standby) state, if the required system load is not greater than a rated output value of the second fuel cell module.

With the above aspect (8), the first fuel cell module whose output is variably controlled based on the required system load is controlled to enter the no-load operation (hot standby) state, if the required system load is not greater than the rated output value of the second fuel cell module. In the no-load operation (hot standby) state, although no power is generated, since the fuel cell module is maintained at the temperature necessary for the operation of the fuel cell or at the temperature close to said temperature, when the required system load increases in the future, power generation by the first fuel cell module is quickly resumed and good load followability is obtained while avoiding energy consumption associated with the start/stop of the fuel cell module.

(9) In another aspect, in any one of the above aspects (5) to (8), the controller controls the second fuel cell module to generate power such that reforming steam necessary to maintain a no-load operation (hot standby) state of the first fuel cell module is supplied by recirculating the second exhaust fuel gas of the second fuel cell module.

With the above aspect (9), since the second exhaust fuel gas is recirculated and supplied to the first fuel cell module, the no-load operation (hot standby) state of the second fuel cell module can be maintained with good efficiency by using the steam contained in the second exhaust fuel gas without supplying steam from the outside.

(10) In another aspect, in any one of the above aspects (5) to (9), the controller controls the second fuel cell module such that reforming steam necessary to maintain a no-load operation (hot standby) state of the first fuel cell module is supplied.

With the above aspect (10), when the first fuel cell module provided in the fuel cell power generation system is maintained in the no-load operation (hot standby) state, the second fuel cell module generates station service power necessary to allow reforming steam necessary to prevent carbon deposition in the first fuel cell module 210A to be supplied, as well as to maintain the fuel cell power generation system 1 in the no-load operation (hot standby) state. Thus, when the required system load increases in the future, power generation can quickly be resumed in each fuel cell module and good load followability is obtained while avoiding energy consumption associated with the start/stop of the fuel cell module.

(11) In another aspect, in any one of the above aspects (1) to (10), the fuel cell power generation system further includes: a second exhaust fuel gas supply line (such as 24C of the above-described embodiment) connecting the second exhaust fuel gas line 22B and an oxidant supply line 42A of the first fuel cell module 210A such that the second exhaust fuel gas Gef2 is supplied to the oxidant supply line 42A.

With the above aspect (11), the second exhaust fuel gas can be supplied to the oxygen-side electrode of the first fuel cell module via the second exhaust fuel gas supply line. Consequently, the second exhaust fuel gas is burned in the oxygen-side electrode of the first fuel cell module, and the first fuel cell module can be controlled to be in the no-load operation (hot standby) state. By thus effectively using the exhaust fuel gas from the second fuel cell module without adding fuel gas from the outside, it is possible to efficiently realize the no-load operation (hot standby) state of the first fuel cell module while suppressing energy consumption.

(12) In another aspect, in any one of the above aspects (1) to (11), the fuel cell power generation system further includes: a second exhaust fuel gas supply line (such as 24D of the above-described embodiment) connecting the second exhaust fuel gas line 22B and an oxidant supply line 42B of the second fuel cell module 210B such that the second exhaust fuel gas Gef2 is supplied to the oxidant supply line 42B.

With the above aspect (12), the second exhaust fuel gas can be supplied to the oxygen-side electrode of the second fuel cell module via the second exhaust fuel gas supply line. Consequently, the second exhaust fuel gas is burned in the oxygen-side electrode of the second fuel cell module, and the second fuel cell module can be controlled to be in the bare minimum low-load operation state. By thus minimizing the supply of the fuel gas from the outside and effectively using the exhaust fuel gas from the second fuel cell module, it is possible to efficiently realize the low-load operation state of the second fuel cell module while suppressing energy consumption.

### REFERENCE SIGNS LIST

1 Fuel cell power generation system
10 Fuel cell part
20 Fuel gas supply line
22A First exhaust fuel gas line
22B Second exhaust fuel gas line
24A Second recirculation line
24B First recirculation line
24C Second exhaust fuel supply line (for first fuel cell module)
24D Second exhaust fuel supply line (for second fuel cell module)
26A First confluent portion
26B Second branch portion
28 Recirculation blower
28A First recirculation blower
28B Second recirculation blower
40 Oxidant supply line
42A First oxidant supply line
42B Second oxidant supply line
42C First exhaust oxidized gas line
42D Second exhaust oxidized gas line
101 Cell stack
103 Substrate tube
105 Single fuel cell
107 Interconnector
109 Fuel-side electrode
111 Electrolyte
113 Oxygen-side electrode
115 Lead film
210 Fuel cell module (SOFC module)
210A First fuel cell module
210B Second fuel cell module
203 Fuel cell cartridge (SOFC cartridge)
205 Pressure vessel
207 Fuel gas supply pipe
207a Fuel gas supply branch pipe
209 Fuel gas exhaust pipe
209a Fuel gas exhaust branch pipe
215 Power generation chamber
217 Fuel gas supply header
219 Fuel gas exhaust header
221 Oxidant supply header
223 Oxidant exhaust header
225a Upper tube plate
225b Lower tube plate
227a Upper heat insulating body
227b Lower heat insulating body
229a Upper casing
229b Lower casing
231a Fuel gas supply hole
231b Fuel gas exhaust hole
233a Oxidant supply hole
233b Oxidant exhaust hole
235a Oxidant supply gap
235b Oxidant exhaust gap
237a, 237b Sealing member
380 Controller
Gef1 First exhaust fuel gas
Gef2 Second exhaust fuel gas
Geo1 First exhaust oxidized gas
Geo2 Second exhaust oxidized gas
Gf Fuel gas
Go Oxidizing gas

1. A fuel cell power generation system, comprising:
a first fuel cell module capable of generating power with a fuel gas;
a first exhaust fuel gas line through which a first exhaust fuel gas exhausted from the first fuel cell module flows;
a second fuel cell module capable of generating power with the first exhaust fuel gas;
a second exhaust fuel gas line through which a second exhaust fuel gas exhausted from the second fuel cell module flows; and
a first recirculation line recirculating from the second exhaust fuel gas line in order to supply the second exhaust fuel gas to a fuel-side electrode of the second fuel cell module.

2. The fuel cell power generation system according to claim 1, further comprising:
a second recirculation line recirculating from the first exhaust fuel gas line in order to supply the first exhaust fuel gas to a fuel-side electrode of the first fuel cell module,
wherein the first recirculation line is connected so as to join the first exhaust fuel gas line upstream of a branch portion from the second recirculation line.

3. The fuel cell power generation system according to claim 2,
wherein each of the first recirculation line and the second recirculation line is provided with a recirculation blower.

4. The fuel cell power generation system according to claim 2,
wherein a recirculation blower for pumping the first exhaust fuel gas is provided, in the first exhaust fuel gas line, between a first confluent portion with the first recirculation line and a second branch portion from the second recirculation line.

5. The fuel cell power generation system according to claim 1, comprising:
a controller for controlling the first fuel cell module and the second fuel cell module based on a required system load,
wherein the controller variably controls an output of the first fuel cell module according to the required system load, and controls an output of the second fuel cell module to a preset constant target value regardless of the required system load.

6. The fuel cell power generation system according to claim 5,
wherein the constant target value is a rated output value of the second fuel cell module.

7. The fuel cell power generation system according to claim 5,
wherein a rated output value of the second fuel cell module is smaller than a rated output value of the first fuel cell module.

8. The fuel cell power generation system according to claim 5,
wherein the controller controls the first fuel cell module to enter a no-load operation state, if the required system load is not greater than a rated output value of the second fuel cell module.

9. The fuel cell power generation system according to claim 5,
wherein the controller controls the second fuel cell module to generate power such that reforming steam necessary to maintain a no-load operation state of the first fuel cell module is supplied by recirculating the second exhaust fuel gas of the second fuel cell module.

10. The fuel cell power generation system according to claim 5,
wherein the controller controls the second fuel cell module to generate minimum power necessary for the fuel cell power generation system to maintain a no-load operation state.

11. The fuel cell power generation system according to claim 1 further comprising:
